(19) United States
(12) Patent Application Publication
(10) Pub. No.: US 2021/0106907 A1
(43) Pub. Date: Apr. 15, 2021

(54) SYSTEMS AND METHODS FOR ACTIVE AND INTERACTIVE GAME PLAY

(71) Applicant: Douglas Reising, Overland Park, KS (US)

(72) Inventor: Douglas Reising, Overland Park, KS (US)

(21) Appl. No.: 16/908,142

(22) Filed: Jun. 22, 2020

Related U.S. Application Data
(60) Provisional application No. 62/958,763, filed on Jan. 9, 2020.
(60) Provisional application No. 62/913,418, filed on Oct. 10, 2019.

(51) Int. Cl. A63F 9/02; A63B 71/02; A63B 71/06; A63F 13/213

(52) U.S. Cl. CPC A63F 9/0291; A63B 71/022; F41J 11/00; A63F 13/213; A63B 71/0622

(57) ABSTRACT

The present invention relates to systems and methods that allow one or more users to actively and interactively play games. The invention combines active game play with virtual reality game play to provide a new and improved experience to players. Players can compete against each other by using a variety of targets and computerized scoring. The invention can track when an object or target is struck or comes in proximity of another object or target. Advantageously, the invention can be used by players of a wide range of ages, skill levels, and physical abilities.

### BACKGROUND OF THE INVENTION

### A. Field of the Invention

The present invention relates to systems and methods for active and interactive game play by one or more users. More specifically, the present invention combines active game play with virtual reality game play to provide a new and improved experience to players of differing abilities.

### B. Description of the Related Art

Recreational facilities provide either live activities, such as bowling alleys, trampoline parks, laser tag, bumper cars, golf, etc., or alternatively, virtual activities such as video gaming. Nowhere have these live and virtual activities been combined into a single experience that has both active and virtual activities in the same game play.

Much of the variation in facilities for live activities relates to differences in lighting or ornamentation rather than in the physical activities themselves. Some variation to standard golf ranges is found in England. For example, in addition to a standard golf range some installations have added permanent targets to parts of their range. These targets are designed similarly to Skee-Ball type targets, i.e. concentric rings, with drainage holes for the balls that enter the rings. The drainage holes are similar to those found in the last hole of a miniature golf course, where the ball travels in a drain permanently installed underground back to the register or cashier booth. Typically, these targets are made of cement with a fabric covering. At some installations the golf balls include RFID tags, and the balls entering the drain in the concentric circles of the target are read as they roll through the drainpipe, which allows the range to keep “scores” as golfers hit balls into the rings.

The current range play options for golfers is quite limited. A golfer has a choice of a standard range with no feedback available to the golfer other than the golfer's own visual feedback, or one can go to a range having permanently installed concentric ring targets. There is no flexibility for the players (golfers) or the ranges for any type of dynamic changes to the range set-up, and limited feedback is available to the golfers trying to improve their game.

Virtual reality and virtual activities depend on inputs from a player responding to depicted events that visually appear on a screen. For example, virtual reality games frequently involve wearing motion transmitters on selected extremities of an individual playing the game. The motion transmitters translate the motion of the extremities into an action that appears on a screen, such as a response of a soccer ball to a simulated kick of the ball by the player.

Video games are frequently controlled by a player's input through a computer keyboard or a game controller. The timing of the activation of the keys or buttons is often a key variable in successfully playing a game. For example, the timing for the discontinuation of a back stroke and the beginning of a fore stroke of a simulated golf stroke, i.e., activation of appropriate keys or buttons, determines the success of a computer-simulated golf shot. In each example, the lack of the physical playing environment, playing conditions, footing, actual equipment, and competitive pressures brought to bear by actual competitors, renders virtual reality games and video games, a separate form of recreation from the sporting events that they try to simulate. Accordingly, limited improvement in an individual's ability to actively play their sport of choice is derived from playing a simulation of the sport. As such, challenges and needs persist for improvements in integrating the actual physical play of a sport with a simulation of the sport to enhance both the skill and enjoyment of the player. It is to these needs and challenges that the present invention is directed.

### SUMMARY OF THE INVENTION

The present invention provides systems and methods relating to a new game that incorporates both physical activities with virtual gaming. Advantageously, these systems and methods allow a wide variety of individuals of differing ages and skill sets to play together.

An objective of a game is to have single or multiple players aim at several moving targets (e.g. miniature vehicles, aerial drones, balloons, or other objects) that are controlled either by one of the players or move along a pre-programed route(s). At certain times the player(s) will attempt to get a moving target or object they are controlling either in contact with or close proximity to another object so that either the proximity or contact of the controlled target is sensed by the other object.

Systems of the invention can incorporate different methods of registering (detecting) if a controlled vehicle or object is in near proximity or physical contact of another object or a specified target. For example, registration or detection can incorporate bar codes, one or more RFID technologies, Bluetooth® technology, or a combination thereof.

Another objective of a game is to have the player(s) aim at specifically identified stationary targets and attempt to contact the identified targets in a particular manner such as with a projectile (e.g. a ball) or laser.

A game includes at least one segment of play. Preferably, a game includes more than one segment of play, and more preferably a game includes multiple segments of play that incorporate mobile targets, stationary targets, or any combinations thereof in any one segment of play.

Player(s) are rewarded for getting their controlled object in close proximity of or in contact with a specified target or object as identified or instructed by the game system. Alternatively, players can be rewarded if they successfully contact a target or object that they are instructed to aim at with a laser gun or a ball shooting gun. Player(s) can be rewarded via a score or other method that enables them to actively play or compete while using a video game type or format style. For example, a “contact score” can be calculated by rewarding points for contacting a specified target with bonus points for quickness in achieving the task. Alternatively, when two or more players or teams are competing against each other a “match play” score can be calculated by using methodology similar to that used in match play golf.

In some embodiments, multiple players can compete against each other while being physically located in different player's suites or even at different facilities. The players can compete by either controlling objects or shooting at targets at the same time.

The invention provides a game system comprising a) a computing system that includes a transceiver, a timer, and an identifier that is linked to a specific player or team; b) one or more player suites having a ball gun, a laser gun, a remote control for a movable game piece, a ball having a label, and a video screen, wherein the label, the ball gun, the laser gun, the remote control, and the video screen are linked to the player identifier; c) at least one field of play having multiple targets and at least one movable game piece, wherein each target and movable game piece includes at least one sensor that sends data to the transceiver; and d) a segment of play, wherein at the initiation of the segment of play the timer is activated and instructions are displayed on the video screen; the player or team operates the ball-gun, the laser gun, the remote control, or a combination thereof as instructed; data are sent from the labels and sensors to the transceiver; and the computing system calculates the player or team score and the score is displayed on the video screen.

Advantageously, the computing system includes multiple identifiers and can send instructions and scores to multiple video screens at the same time.

Targets or objects of the game system include at least one sensor that is capable of detecting a scoring contact and transmitting the contact to the computing system. Preferably, the sensor, or alternatively another sensor that is incorporated into or attached to the target, can identify the source of the scoring contact and transmits that data to the computing system.

At least one sensor in or attached to a target or object is an infrared sensor that can detect when contact is made by using a laser gun or an analogous device.

Systems of the invention include a laser gun that is linked to a specific player's suite such that the computing system is able to identify the specific player's suite so that hits by the laser gun can be associated with the score of the correct player or team.

Balls that are shot from the ball gun include at least one sensor that is capable of transmitting a scoring contact to the computing system. Preferably, this sensor is the same sensor that is scanned by the player or team in the player's suite, but in the alternative, a second sensor can be used. In preferred embodiments the label in a ball is a RFID tag. Those of skill in the art will appreciate that other types of labels (e.g. a bar code) can be either inserted into or attached to a ball that can be shot from a ball gun.

At least one target, preferably more than one target, includes two sensors or even more than two sensors. Targets that have more than one sensor include at least a first sensor that is an infrared sensor and a second sensor that is a RFID tag.

The invention provides that at least one target is an airborne target. Airborne targets have an infrared sensor. Examples of suitable airborne targets are drones, balloons, or objects that are elevated by a column of air.

Remote-controlled vehicles that are included in systems and methods of the invention include at least one sensor capable of transmitting a score to the computing system. Preferably, the sensor is capable of detecting either a scoring contact or a proximity score.

The invention also provides methods of playing a game that comprise a) enabling a computing system to recognize an identifier that is linked to a specific player or team and to assign a player's suite to the specific player or team; b) sending playing instructions from the computing system to a video screen in the assigned player's suite; c) activating a segment of play by starting a timer in the computing system; d) using a ball gun, a laser gun, a remote control for a movable game piece, or a combination thereof to contact one or more targets on a field of play; e) transmitting the number of contacts to the one or more targets made by the specific player or team for a measured period of time to the computing system and calculating the player's or team's score for the segment of play; and f) sending the player's or team's score to the video screen.

Methods of the invention further comprise activating at least two segments of play; calculating the player's or team's scores for each segment of play; and calculating a total score for the player or team. Scoring can be calculated by contact, match play, or a combination thereof.

The invention provides that segments of play can occur simultaneously or consecutively.

Advantageously, methods of the invention provide that a player or team can add information or choose from multiple games to play at the video screen.

In preferred methods of the invention, the timer counts down for a selected period of time.

The invention provides that a movable game piece is remotely controlled by the computing system, another player, or another team. Advantageously, an operator of the invention can elect whether to have the computing system direct movable game pieces to move along pre-programmed routes during times of high occupancy or use, or when suitable to allow players or teams to choose the route of a movable game piece.

Advantageously, systems and methods of the invention allow a first player or team to use one segment of play while another player or team uses a different segment of play.

Herein, “active” refers to play, activity, or targets that are not virtual (i.e. physical activity(ies) or a physical object(s) is included). Such active play, physical activity or targets may be combined with virtual scoring or other virtual activities or environments.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description. Further, while specific advantages of the invention are detailed herein, various embodiments may include some, none, or all of these enumerated advantages.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description presented herein. Unless specifically noted, articles depicted in the drawings are not necessarily drawn to scale.

FIG. 1. Illustrates a perspective view of an exemplary layout for a game complex that houses areas where players are located adjacent to the field where targets are placed or move.

FIG. 2. Illustrates an exemplary multi-storied player suite.

FIG. 3. Illustrates another exemplary layout for a game complex with player suites on all four sides of a rectangular layout.

### DETAILED DESCRIPTION

The invention provides systems and methods that combine active play with virtual play into a unified experience. Advantageously, the invention allows one or more players to aim and shoot at one or more targets that are either active or virtual.

The invention combines existing technologies into a new game experience that is challenging and visually stimulating in either an outdoor or indoor environment. Unlike existing modified golf ranges, miniature golf, or other environments that used fixed targets, some or even all of the targets of the present invention are mobile.

Users can play from individual suites that can accommodate multiple players at one time. Users can play games that include pre-programmed targets. Alternatively, one player can control a target (e.g. remotely drive a vehicle) while another player attempts to either hit or come into close proximity of the target.

Those of skill in the art will understand that the order of play of the different segments of a game can be varied. For example, in one instance players first play a game segment using laser guns then play a segment that uses remote-controlled vehicles. In another instance, the players first play a segment that includes remote-controlled vehicles followed by a segment that uses laser guns or paintball guns.

In one task or game segment, players use laser guns and aim at targets (e.g. vehicles) or other objects that have sensors similar to those used in the laser tag industry. In some instances, these sensors can be attached to aerial targets such as flying drones or other targets that can be raised or lowered. Such sensors include systems and software that are readily adaptable to the present invention and can detect when a player “hits” a laser sensor. Players are rewarded based on their successfully hitting targets, vehicles, or other objects by a score or other feedback similar to the format commonly used in a video game, or alternatively, by a match play scoring system.

In another task or game segment, players remotely control vehicles or other objects on the field of play, so that the vehicles or objects come in close proximity or contact with one another. Preferably, players are instructed to touch, or come into close proximity, with a specific vehicle(s) or object(s) during game play. When the player gets their vehicle in contact or close proximity of the target vehicle, the contact or proximity is detected by an appropriate sensor, and the reading by the sensor is remotely communicated to the controlling computer so that the player's score (or hit) can be recorded. Players are rewarded for successfully hitting a target with a score. Rewards (points) can also be awarded based on the amount of time taken to successfully contact a target. For example, more points are awarded to a player for speedier, successful play.

### Fields

A field can be outfitted with a variety of realistic or fantastic themes, so that the field is visually stimulating and engaging. The players can aim and shoot at vehicles, clusters of targets (e.g. television or computer screens, balloons, etc.), or other objects with a laser gun, ball gun, or other active armament or tool (e.g. club, bat, racket, etc.) that is used in playing a sport to hit a target.

Those of skill in the art will understand that fields can have a variety of shapes and sizes. A field's size and shape will depend upon the types of targets used, whether aerial targets are used, whether the field is level or includes any variation in elevation. A field's size and shape will also depend upon whether the field is located indoors, outdoors, on land, or on water.

For example, an outdoor field may have the targets located over water such that targets are anchored or tethered below the water line and can be raised or lowered below the water line or moved along pre-determined routes through the water. Players suites can be located in a beach area adjacent to the field. Advantageously, these types of beach suites and fields can be relatively mobile so that an area can be used for swimming by day and for play at after dark.

In another example, fields and player suites can be located on land configured to be reminiscent of the spokes of a wheel or pie-shaped. In this example, the player suites are located near the center of the wheel or pie and the fields extend outward to the perimeter of the wheel or pie. Advantageously, these types of fields can be relatively temporary and provide a second use of softball/baseball fields or arenas that are not otherwise occupied.

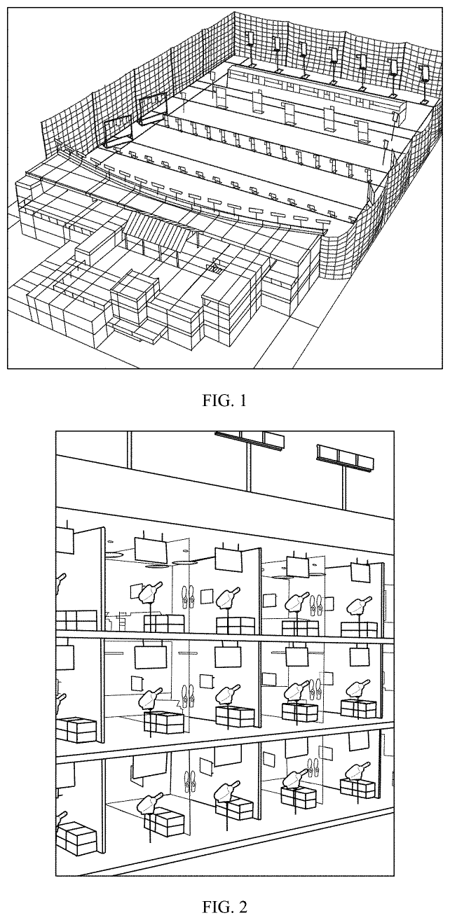

Outdoor facilities may include a net around the field so that drones or other targets are unable to stray from the field area. See FIG. 1.

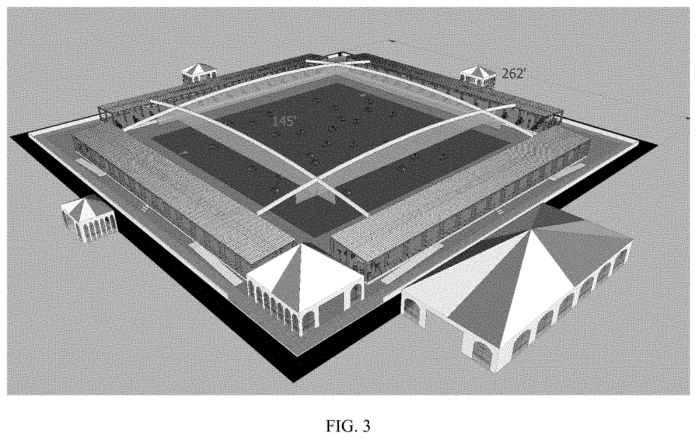

Preferably, a field is designed such that the players can readily see and aim at all the targets, vehicles, clusters of targets (e.g. television or computer screens), objects or drones. See FIGS. 1 and 3. Generally, square or rectangular fields are preferred, but other configurations can also be used.

Most indoor facilities are expected to be relatively square or rectangular in shape. Players suites can be located along one, two, three, four, or more sides. It is preferred that in these facilities the player suites are located around the outer perimeter of one or more fields. See FIGS. 1 and 3. Players suites can be immediately adjacent to the field, but a preferred configuration offsets the suites from the field. The amount of the offset depends upon the size of the field, as well as, the types of equipment that are used by players.

In some facilities, it may be advantageous to include a net(s) to separate different sides of suites. Alternatively, nets or other barriers (mobile or permanent) can be used to separate a large area into multiple fields of play. Advantageously, separating a large area into multiple fields allows for multiple themes to be available at any one time and further enhancing the playing experience.

One preferred size for an indoor facility is a field about 143 ft by 143 ft. It is expected that the height of a field should be at least about 11 ft. Field heights can be higher.

Fields can be constructed so that mobile targets (e.g. miniature vehicles) travel over various type of terrain. Obstacles can be placed on the field and can be moved as desired and to increase variety. Outdoor fields can be lit and played after dark. Indoor fields can be lit artificially or naturally (e.g. skylights). Targets such as vehicles, drones, or other objects can be illuminated, glow in the dark, include other special lighting, include sounds or other special effects that are intended to enhance the playing experience.

Fields can be constructed so that they can be viewed and played from multi-storied play areas (suites). See FIG. 2.

### Targets

Mobile targets can be remotely controlled vehicles or other objects on a field of play. The mobile targets can be controlled either by another player or team or pre-programmed to travel along a preferred path or route. Such paths or routes can be aerial, terrestrial, or a combination thereof.

Players may shoot at target vehicles or objects with a ball shooting gun that shoots balls that are embedded with an RFID tag (chip) or enabled with Bluetooth® (i.e. short-wavelength UHF radio wavelength) technology. The RFID chip or short-wave UHF signal allows for multiple players to shoot at the same target while allowing each player's score to be measured and recorded separately from those of other players.

Examples of suitable sensors include RFID chips or bar codes that are included or attached to a target vehicle or object. It is expected that different types of sensors will be preferred in different targets or fields of play. It is only necessary that the sensor be able to detect either the contact or proximity of a player's laser, remotely controlled vehicle, or other manner of successfully scoring on a target. Data from a sensor(s) can be transmitted to a controlling computer by either a wired or wireless transmission. Such types of transmission by wireless or wired sensors, RFID chips or antenna, or short-wave UHF radio signals (e.g. Bluetooth®) are known in the art.

Alternatively, or in addition, RFID chips or tags or other suitable sensors can be embedded in, placed on, or underneath the surface of a field at regular intervals (e.g. horizontally every 18 to 36 inches). Other types of suitable sensors that can be placed on or as part of the surface of the field include those that can be “painted” onto the surface and detected with doppler tracking or analogous technology. Such targets can be any suitably detectable size or shape. These sensors can detect the vehicles or objects that have RFID antennas and can transmit the location of the vehicles or objects back to the host computer so the movement of the vehicles or objects can be tracked or controlled by the system rather than by individual players. Advantageously, the location of each object or vehicle can be tracked in real time so that it can be used during a game to determine the relative location of a given object or vehicle to another object or vehicle.

### Basic Play

Players can select from a variety of games. Each game has multiple segments of play, and each segment of play may be different from another segment. Players can select from pre-designed games or combine various segments to create their own custom games. Players can attempt to beat their own best scores or compete against each other. It is expected that as the number of fields (installations) grow, players can play against other players (or teams) at different locations. Advantageously, players can track their history and communicate with other players as they choose by using computer applications (e.g. cellular phone apps).

To begin, a customer or player purchases a unique identifier, for example a membership card, at a point of sale (e.g. a cashier when they enter a facility). The customer proceeds to one of the suites located at the facility. The suite may be assigned when the customer checks in at the point of sale, or alternatively, the customer can be allowed to choose a player suite. The customer goes to an interactive touch screen, or analogous device, located at the suite, selects the desired game(s) to play, and enters the number of players and any other necessary information (e.g. unique identifier, skill levels, teams, etc.). The customer can choose how many players at each of the individual suites will be playing. Advantageously, a customer can link multiple suites to a single identifier. For example, a customer can be an employer that may wish to reserve multiple suites for employees to play as part of a company outing.

Specific equipment (e.g. ball shooting gun, laser gun, etc.) is assigned to a specific game suite such that when the equipment is used, all scoring data are directed to the specified suite. Once a game begins, a video screen in the suite is activated to display the chosen game. Preferably, the video screen is a large screen that shows the game action in real time and displays the current score of each player or team, the time remaining for each player or team to complete a particular game segment (e.g. hit a target), and the total time left in the game. At the end of a game the total score or winner of each segment can be displayed on the screen.

### Operation

At the beginning of a game, all of the remote-controlled vehicles, objects, or other targets are set out on a field. Mobile targets may be moving along pre-programmed routes. In the case of airborne objects or clusters of targets (e.g. television or computer screens), preferably they are elevated off the ground at the beginning of a game. Each target can have one or more sensor mechanisms that can detect when a laser from a laser gun has hit the sensor (i.e. hit the target). A target can also include a bar code, RFID sensor, or Bluetooth® sensor that can detect when a vehicle, object, or other target has either come into close proximity or contact with another vehicle or object that is directed by a player. Aerial targets only include laser (i.e. infrared) sensors as they are not intended to come into contact with other objects or targeting mechanisms.

When a game starts, a player(s) can shoot a laser gun at the vehicles, flying objects, or other targets when instructed to do so. Instructions are viewable by players on the video screen. “Hits” are detected by sensors on targets and are recorded by the system's computer control and scored for the player or team to which the laser gun is assigned for that game or game segment.

Alternatively, players can shoot balls at targets from a ball shooting gun. Each ball includes a unique bar code, RFID chip or tag, or Bluetooth® sensor embedded or attached to it. Prior to shooting, a player scans the sensor in the ball with a bar code reader, or RFID or Bluetooth reader in the suite before placing it into the ball shooting gun. In this manner, the game system can identify which ball is shot from which gun (or by which player or team it is shot) so that upon successfully hitting a target, the game system can record a score and transmit that score for the player or team to the correct suite.

If the player is shooting the laser gun the system is programmed to recognize which laser gun hit the target since every gun is assigned to a specific player suite. Further, the players have self-identified who the players are prior to the beginning of a game, and the game instructs which player is to operate the laser gun during the game. So, when a gun hits a laser sensor/target in the field the game system can identify which gun hit the target and can send the information to the correct suite from which the gun was shot. In this manner the correct suite and associated monitor screen will receive the correct score and feedback (e.g. speed and accuracy of player) about successfully hitting a target.

Preferably, a central computer is located at the facility and is connected to the individual player suites and their associated viewing screens (monitors). The central computer includes the game software and controls each game being played in each suite. The sensors on aerial and ground based targets continually feed updated information regarding when and which targets are hit via standard wireless technology to the central computer. During operation, the central computer continually receives incoming information from targets' sensors and processes the information. In this manner each game and monitor at each suite is continually updated in real time so that the game is refreshed and scoring is kept updated.

### Scoring

Scores can be an accumulation of points awarded for accuracy and speed. A player can receive additional points (or other reward) for every second remaining on the timer. For example, if 110 seconds are left on the countdown clock (timer) when the player hits the final target then the player can receive an additional 110 points, or alternatively the player advances a corresponding amount if the game includes moving through a virtual world to a goal. The reward depends upon the particular game being played.

If the time runs out and not all of the targets have been contacted or scored on, then the player gets fewer (or no) points or does not advance as far (or at all) in the game. If a player hits or comes near one of the other vehicles or other objects on the field that they were not instructed to target, then the player can receive a negative consequence to their score or position in the game.

### Example of Play

Those of skill in the art will appreciate that the different segments of game in the following exemplary description may be re-organized into a variety of different orders without adversely affecting the functionality of the game. This description is not intended to limit the type or number of games that can be offered but is an example of how all the components work together to facilitate a game.

When a game begins the video screen, preferably a big screen, is activated and shows the chosen game. Instructions to a player or team are shown on the video screen (monitor). In a first segment of play, a player may be instructed to drive a remote-control vehicle to get in close proximity, or even touch or contact, other vehicles or targets that are located on the playing field. For example, the game shown on the video screen can instruct the player visually or audibly to hit or come near vehicles designated by a code (e.g. A7 or B6) or another identifier (e.g. flashing light, flying dragon, etc.).

The monitor also shows a count-down clock starting with a certain number of seconds, for example 300. The clock continues to count down until the player either successfully hits or comes into proximity of all the targets as instructed or time expires.

After all of the players in the suite have had a round of driving the vehicle or targeting the object as described, the next segment of a game begins. For example, a player is instructed (visually or audibly) to fire a laser gun at a certain number, or an unlimited number, of specifically identified vehicles or objects (i.e. the targets) on the field. Again, the segment of play can be played for a specified period of time (e.g. 300 seconds) for each player or team.

In a similar manner, a player may be instructed to shoot at specified targets using a ball shooting gun. Before firing the gun, the player obtains a ball that has an RFID chip or other identifying sensor from a bin in the suite and scans it. Once the scanner indicates that the ball's sensor has been read, the player loads the ball into the gun and shoots the ball as directed.

For example, a player has a specified amount of time to hit all three targets (e.g. a vehicle, an object, and an airborne target) in order to receive the maximum number of points or to advance in the game. If only two of the three targets are hit in the allotted time, then the player receives fewer points or does not advance as far in the game. If only one target is hit, then the player receives even fewer points or advancement. If no targets are hit, then no points or advancement are awarded. Points may be deducted from the player's score or a player may regress in the game if the player hits the wrong targets (i.e. targets on the field that the player was not instructed to hit).

Advantageously, by incorporating live action with video instructions and scoring, several players in a suite can play different segments of the game at the same time. For example, the players can alternate after every round (segment of play) between driving a vehicle or object and shooting a laser gun or shooting a ball shooting gun at specified targets on the field. When time expires or the game is over, the final scores can be calculated, and the winner displayed on the screen.

Unless defined otherwise, all technical and scientific terms used herein have the same meaning as is commonly understood by one of skill in the art to which this invention belongs at the time of filing. Terminology used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. Furthermore, the use of the term “including”, as well as other forms such as “includes” and “included” is not limiting. As used herein, “each” refers to each member of a set or each member of a subset of a set. All patents and publications referred to herein are incorporated by reference herein.

Those of skill in the art should, in light of the present disclosure, appreciate that many changes can be made in the specific embodiments that are disclosed and still obtain a like or similar result without departing from the spirit and scope of the invention. Thus, the present invention should not be limited to the exemplary embodiments and techniques illustrated herein.

What is claimed is:

1. A game system comprising
a) a computing system that includes a transceiver, a timer, and an identifier that is linked to a specific player or team;
b) one or more player suites having a ball gun, a laser gun, a remote control for a movable game piece, a ball having a label, and a video screen, wherein the label, the ball gun, the laser gun, the remote control, and the video screen are linked to the player identifier;
c) at least one field of play having multiple targets and at least one movable game piece, wherein each target and movable game piece includes at least one sensor that sends data to the transceiver; and
d) a segment of play, wherein at the initiation of the segment of play the timer is activated and instructions are displayed on the video screen; the player or team operates the ball-gun, the laser gun, the remote control, or a combination thereof as instructed; data are sent from the labels and sensors to the transceiver; and the computing system calculates the player or team score and the score is displayed on the video screen.

2. The game system of claim 1, wherein the computing system includes multiple identifiers and can send instructions and scores to multiple video screens.

3. The game system of claim 1, wherein the label in the ball is a RFID tag.

4. The game system of claim 1, wherein at least one target includes two sensors.

5. The game system of claim 4, wherein a first sensor is an infrared sensor and a second sensor is a RFID tag.

6. The game system of claim 1, wherein at least one target is an airborne target.

7. The game system of claim 6, wherein the airborne target has an infrared sensor.

8. The game system of claim 1 having two or more fields of play.

9. The game system of claim 1 further comprises multiple segments of play.

10. A method of playing a game that comprises
a) enabling a computing system to recognize an identifier that is linked to a specific player or team and to assign a player's suite to the specific player or team;
b) sending playing instructions from the computing system to a video screen in the assigned player's suite;
c) activating a segment of play by starting a timer in the computing system;
d) using a ball gun, a laser gun, a remote control for a movable game piece, or a combination thereof to contact one or more targets on a field of play;
e) transmitting the number of contacts to the one or more targets made by the specific player or team for a measured period of time to the computing system and calculating the player's or team's score for the segment of play; and
f) sending the player's or team's score to the video screen.

11. The method of claim 10 further comprises activating at least two segments of play; calculating the player's or team's scores for each segment of play; and calculating a total score for the player or team.

12. The method of claim 11, wherein the segments of play occur simultaneously or consecutively.

13. The method of claim 10, wherein two or more players or teams compete against each other and the computing system calculates their scores by contact count or match play scoring.

14. The method of claim 10, wherein the player or team can add information or choose from multiple games to play at the video screen.

15. The method of claim 10, wherein the timer counts down for a selected period of time.

16. The method of claim 10, wherein a movable game piece is remotely controlled by the computing system, another player, or another team.

17. The method of claim 10, wherein the ball gun, the laser gun, the remote control, and at least one ball having a label is linked to the identifier.

18. The method of claim 10, wherein at least one target is an airborne target.

19. The method of claim 10, wherein the one or more targets include an infrared sensor.

20. The method of claim 19, wherein at least one target further includes a RFID sensor.
